(19) United States
(12) Patent Application Publication
(10) Pub. No.: US 2023/0289278 A1
(43) Pub. Date: Sep. 14, 2023

(54) Populating Datastores For Integration Testing

(71) Applicant: Google LLC, Mountain View, CA (US)

(72) Inventors: Srinath Badrinath, Bangalore (IN); Benson Margulies, Seatlle, WA (US); Aakanksha Ashok, Bangalore (IN)

(21) Appl. No.: 17/690,579

(22) Filed: Mar. 9, 2022

(51) Int. Cl. G06F 11/34; G06F 11/36; G06F 16/21

(52) U.S. Cl. CPC G06F 11/3457; G06F 11/3664; G06F 16/21

(57) ABSTRACT

Aspects of the disclosure are directed to populating test datastores in a computing environment for integration testing. A datastore populator system identifies the datastore relationships between tables of multiple different datastores and populates data according to those identified relationships when the relationships are not explicitly defined by a database schema or documentation. A datastore relationship can refer to data shared across the same or different datastores. Aspects of the disclosure provide for identifying those implicit relationships for populating test datastores for use in testing a service or application, to accurately simulate the interaction between multiple relational datastores. Relationships between values of columns across tables may be referred to as invisible foreign key relationships. A relationship is “invisible” because it is not explicitly defined, for example in a datastore schema, but nonetheless exists based on the interaction between different services updating various tables and receiving data from one table to another.

### BACKGROUND

Integration testing is a type of software testing in which multiple software services or applications are tested together. One or more services, called microservices, collectively operate as an application, for example a user-facing application hosted on a computing platform. When a new microservice is to be integrated into the application, the collection of microservices and the new microservice may be subjected to various tests to identify any potential errors arising as a result of integrating the new microservice. Microservices may depend on data generated by other microservices in the application. These dependencies are not always documented or explicitly defined, for example in a database schema.

As part of performing an integration test, a test environment may be deployed, which may include a number of datastores with test data simulating production data processed by the microservices during production. Because microservices may have dependencies to data provided by other microservices that are not documented or explicitly defined, the generated test data does not accurately represent production conditions, even if the test data otherwise matches the type and volume of data the application may encounter in production.

### BRIEF SUMMARY

Aspects of the disclosure are directed to populating multiple test datastores in a computing environment for integration testing. A datastore populator system identifies the datastore relationships between tables of multiple different datastores and populates data according to those identified relationships. A datastore relationship can refer to data shared across columns or rows of tables, across the same or different datastores. Aspects of the disclosure provide for identifying those implicit relationships for populating test datastores for use in testing a service or application, to accurately simulate the interaction between multiple relational datastores. Relationships between values of columns across tables may be referred to as invisible foreign key relationships. A relationship is “invisible” because it is not explicitly defined, for example in a datastore schema, but nonetheless exists based on the interaction between different services updating various tables and receiving data from one table to another.

Aspects of the disclosure provide for a method for populating test data in a test environment for a plurality of production datastores including a plurality of tables, the method including: receiving, by one or more processors, one or more datastore requests for the plurality of production datastores; identifying, by the one or more processors, and using the one or more datastore requests, one or more invisible foreign-key relationships between respective pairs of tables in the plurality of production datastores; generating, by the one or more processors, a directed graph, wherein each of the plurality of production datastores is represented by a respective node of the directed graph and each identified invisible foreign-key relationship is represented by a respective edge between a first node and a second node of a respective pair of tables corresponding to the invisible foreign-key relationship; topologically ordering, by the one or more processors, the directed graph; and populating, by the one or more processors and using the ordered graph, the test environment with the test data, the test data satisfying the identified one or more invisible foreign-key relationships.

Aspects of the disclosure provide for a system including: one or more processors configured to: receive, by the one or more processors, one or more datastore requests for the plurality of production datastores; identify, by the one or more processors, and using the one or more datastore requests, one or more invisible foreign-key relationships between respective pairs of tables the plurality of production datastores; generate, by the one or more processors, a directed graph, wherein each of the plurality of production datastores is represented by a respective node of the directed graph and each identified invisible foreign-key relationship is represented by a respective edge between a first node and a second node of a respective pair of tables corresponding to the invisible foreign-key relationship; topologically order, by the one or more processors, the directed graph; and populate, by the one or more processors and using the ordered graph, the test environment with the test data, the test data satisfying the identified one or more invisible foreign-key relationships.

Aspects of the disclosure provide for one or more non-transitory computer-readable storage media having instructions that when executed by one or more processors, causes the one or more processors to perform operations, including: receiving one or more datastore requests for the plurality of production datastores; identifying using the one or more datastore requests, one or more invisible foreign-key relationships between respective pairs of tables in the plurality of production datastores; generating a directed graph, wherein each of the plurality of production datastores is represented by a respective node of the directed graph and each identified invisible foreign-key relationship is represented by a respective edge between a first node and a second node of a respective pair of tables corresponding to the invisible foreign-key relationship; topologically ordering the directed graph; and populating, using the ordered graph, the test environment with the test data, the test data satisfying the identified one or more invisible foreign-key relationships.

Aspects of the disclosure can include one or more features, including, for example, the following features, alone or in combination. In some examples, aspects of the disclosure provide for all of the following features, together.

Receiving, by the one or more processors, the one or more datastore requests to the plurality of production datastores includes: intercepting the one or more datastore requests over a network connecting the plurality of production datastores with a requesting device; and storing the one or more datastore requests in persistent storage.

Intercepting the one or more datastore requests includes intercepting only read requests for reading request results from the plurality of production datastores.

Identifying, by the one or more processors, and using the one or more datastore requests, the one or more invisible foreign-key relationships, includes: executing the one or more datastore requests to generate one or more request results, wherein each request result corresponds to a record of a respective table with a primary-key identifier stored in a column of the respective table; and comparing, for a first request result, the primary-key identifier for the first request result with primary-key identifiers in other tables, and for each matched primary-key identifier, identifying an invisible foreign-key relationship between the table storing the first result and the table storing the result corresponding to the matched primary-key identifier.

The test data includes at least a portion of the one or more request results.

The directed graph includes a progress state table, and topologically sorting the directed graph includes updating, for each node, the progress state table with a name of a datastore represented by the node and a respective level in the ordering for the datastore.

Populating the test environment data includes: traversing the ordered graph; and populating data across tables for each node concurrently, in accordance with the updated levels in the progress state table.

Populating the test environment includes: populating the test environment with the test data using the progress state table of the directed graph to satisfy the one or more identified invisible foreign-key relationships.

The method or operations further include identifying a circular dependency between two or more production datastores, according to the topological sorting; and replacing nodes corresponding with the two or more production datastores with a composite node, the composite node connected to one or more nodes according to edges for nodes to the two or more production datastores.

The directed graph is a directed acyclic graph (DAG).

### BRIEF DESCRIPTION OF THE DRAWINGS

FIG. 1 is a block diagram of a datastore populator system generating test data for a test environment, according to aspects of the disclosure.

FIG. 2A is an illustration of interrelated services in a production environment.

FIG. 2B is an illustration of invisible foreign-key relationships among tables of production datastores.

FIG. 3 is an illustration of an example directed graph and progress state table generated by the database populator system, according to aspects of the disclosure.

FIG. 4 is a flow diagram of an example process for populating a test environment with test data, according to aspects of the disclosure.

FIG. 5 is a block diagram of an example environment for implementing the datastore populator system.

### DETAILED DESCRIPTION

### Overview

Aspects of the disclosure are directed to populating multiple datastores in a test computing environment for integration testing. A datastore populator system identifies the datastore relationships between tables of multiple different datastores in production and populates data according to those identified relationships. A datastore relationship can refer to data shared across columns or rows of tables, across the same or different datastores. Even when two datastores are independent of one another according to datastore schema definitions, implicit, undocumented, relationships may exist between tables of the different datastores.

Aspects of the disclosure provide for identifying those implicit relationships for populating test datastores for use in testing a service or application. The system populates data, for example, with synthetic data, existing data, or a combination of the two, which accurately simulates how data across different tables depend on one another in production relational datastores.

Relationships between values of columns across tables may be referred to as invisible foreign key relationships. A relationship is “invisible” because it is not explicitly defined, for example in a datastore schema, but nonetheless exists based on the interaction between different services updating various tables and receiving data from one table to another. An invisible relationship does not have an explicit definition, for example in a database schema.

For example, the values of data in a first table in a first datastore may depend on the values of data in a second table in a second datastore. To generate test data that accurately simulates this dependency, a corresponding first table in a test environment should have data generated from a corresponding second table in the test environment. If test data were to be generated randomly without this invisible foreign-key relationship being satisfied or met, then datastores in the test environment would not accurately reflect how data is interconnected in a production environment.

By identifying relationships between tables across different datastores, aspects of the disclosure provide for improving the generation of testing data during integration testing, over approaches in which testing data is generated randomly and relying only on explicitly defined foreign-key relationships. This is at least because identifying implicit dependencies among the tables can be used later to generate test data that is more like data in production datastores. This similarity can result in better and more accurate integration testing, versus approaches in which implicitly related values are ignored.

A datastore populator system can intercept datastore requests sent to and from a datastore management system managing multiple datastores. Details from intercepted datastore requests, such as datastore name, table names, and other information, are encrypted and stored in persistent storage. The datastore requests can be stored as logs, where each log entry corresponds to a respective intercepted datastore request. Using the intercepted datastore requests, the datastore populator system can find the intersection between tables of different datastores using row-level values at a column-level for results of the datastore requests and identify one or more invisible foreign key relationship between tables for each intersection.

As part of identifying the invisible foreign key relationships, the datastore populator system can generate a data structure, such as a directed graph, representing datastores having multiple tables. Nodes of the graph can represent datastores. Edges between the nodes represent datastore relationships identified by the datastore populator system. Initially, the nodes can be unconnected, and the system can iteratively identify datastore relationships and update the graph with corresponding edges representing those relationships. Each node is associated with a primary key value map, which the datastore populator system updates with the primary keys of results in response to intercepted requests to that table or datastore. Each table includes a primary key column, storing primary keys for records or rows of data stored in the table.

The datastore populator system loads the stored datastore requests, organizes the datastore requests by target datastore, and executes the datastore requests. Results to the datastore requests are stored in temporary memory. The system iterates through the query results and updates the primary key value map with the respective primary key for each datastore request result. A primary key for a record in a datastore is generally a universally unique identifier, meaning that if the record is shared between tables (or even between different datastores), primary keys for identical records should match. For each primary key value map of each node, the system compares each primary key value in the map with the primary key values in maps for other nodes, for example using a reverse map lookup datastore operation. For every matched pair of primary key values between a respective first and a respective second datastore, the system updates the graph with an edge from a column of the first table in the first datastore to a matching column of a second table in the second datastore. The system can repeat this process until iterating through all of the query results stored in memory.

The datastore populator system can manage a progress state table, storing a respective level associated with each table, and used to track the order at which to populate a test datastore. The datastore populator system can traverse and topologically sort the graph, storing the names and levels of tables in the datastores. For example, a table may have a level of 1, for having a row with a value dependent on the value of a second table in a different datastore. If the value in the second table is not dependent on the value of another table, then the graph can represent the second table as having a level of 0 for that relationship. Different tables can have multiple levels on a value-by-value basis.

Using the state progress table, the data populator system can populate test datastores in parallel with concurrency control using the level fields for each table, to ensure that no table or datastore is populated before its parents, for example, tables or datastores with lower levels. The data used to populate the test datastores can be synthetic, for example randomly generated, or generated using the intercepted datastore requests.

Aspects of the disclosure provide for at least the following technical advantages. A datastore populator system is datastore- and computing platform-agnostic in generating testing data for integration testing. The datastore populator system can scale with increasingly complex interdependencies between various microservices or services provided by a platform, across multiple datastores. The system can generate less data overall, by selectively reusing data for values across tables or datastores previously identified as having invisible foreign-key relationships. As a result, the system can populate data faster and with a smaller data storage footprint. In addition, the system can maintain the datastore relationships between the different datastores and tables within each datastore, to better emulate characteristics of data in production datastores.

Although described in the context of integration testing, aspects of the disclosure provide for populating multiple relational datastores with test data satisfying invisible foreign-key relationships, to better simulate the interdependencies of data in a production environment of relational datastores. Further, the various services of a production environment need not be microservices but can be independently developed applications that rely at least partially on data stored in different datastores corresponding to other applications.

Interdependencies can be identified as invisible foreign key relationships, without the need to update and maintain datastore schemas explicitly defining these relationships beforehand. This increased flexibility over approaches requiring explicitly defined relationships has the advantage for more efficient extension of additional microservices offered by a computing platform or environment, which is consistent with the advantages that this paradigm brings over the more rigid monolithic application or service-oriented architecture approach.

For mature or legacy services with well-defined integration test suites, the datastore populator system can trim the unnecessary rows by populating only the rows that are read from the intercepted datastore requests. The rows that are read are the rows that are needed by the test targets or test environments to validate the functionality. In this way, the datastore populator system can integrate easily into existing services.

### Example Systems

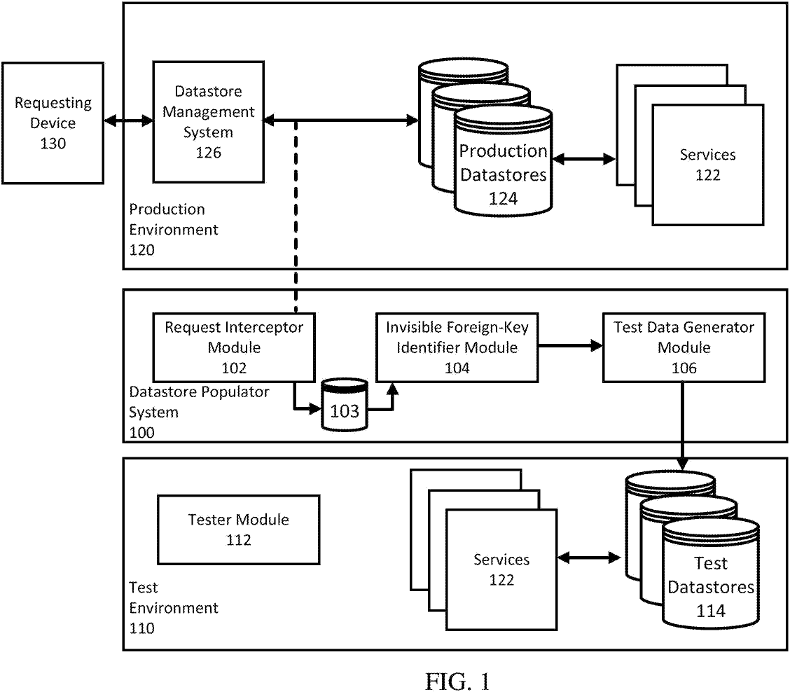

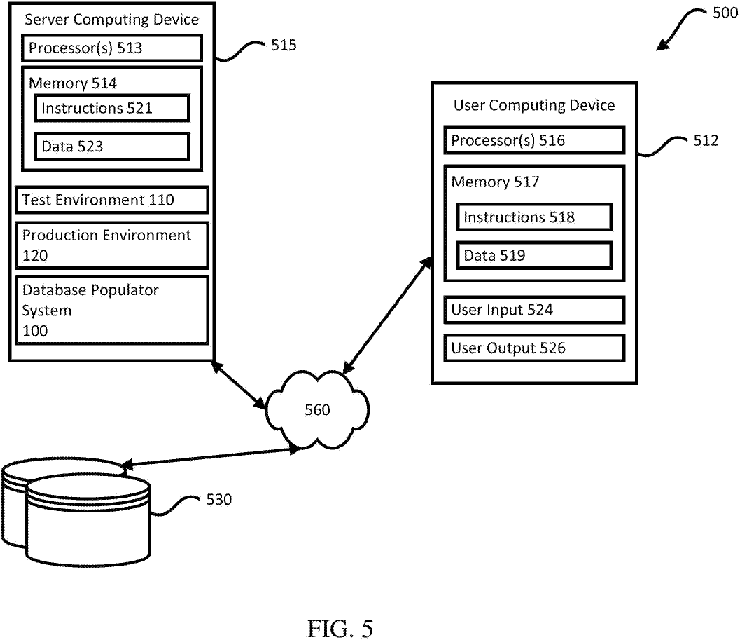

FIG. 1 is a block diagram of a datastore populator system 100 generating test data for a test environment 110, according to aspects of the disclosure. FIG. 1 also shows a production environment 120. As described herein with reference to FIG. 5, the production and test environments 110, 120 can include one or more servers or other computing devices which may be located at one or more locations. “Production” can refer to when services 122 are live and may be actively accessed by a requesting device 130 to request and receive data processed by the services 122. The environments 110, 120 can host a variety of services 122, for example microservices of an application hosted on a computing platform. The services 122 can be interrelated according to a variety of different technologies, such as through remote procedure calls (RPCs) and/or an Application Programming Interface (API) implemented in accordance with REST (Representational State Transfer) architectural style. Other example techniques for interconnecting the services 122 are also possible.

Production data stored at production datastores 124 may be used to support operations of the services 122, or other types of applications. In this specification, a datastore can be any source of persistent storage, such as any type of non-transitory computer readable medium capable of storing information, such as a hard-drive, solid state drive (including non-volatile memory express (NVMe) drives), tape drive, optical storage, memory card, ROM, RAM, DVD, CD-ROM, SD card, write-capable, and read-only memories. An example of a service can be a microservice or an application. A datastore can be a relational database, for example managed by a database management system (DBMS) 126 or similar. A datastore can store one or more tables, each table having a number of columns and records or rows.

The requesting device 130 can be, for example, a user computing device configured to communicate with the DBMS 126 over a network. As described in FIG. 5, a requesting device can be connected to the DBMS 126 over a network according to a variety of different technologies.

The DBMS 126 can be configured to receive datastore requests, for example as RPC calls, to read or write data from or to the production datastores 124. Test datastores 114 of the test environment 110 may also be managed by a DBMS (not shown). The structure and number of test datastores 114 can mirror the production datastores 124. As described herein, the system 100 can populate test data in the test datastores 114 according to invisible foreign-key relationships identified among tables in the production datastores 124. The DBMS 126 or another component of the production environment 120 can receive the datastore requests as logs, which can be stored and retrieved by a request interceptor module 102 of the system 100, to construct the datastore requests.

The production datastores 124 may include multiple tables, whereby at least some of the stored tables include data accessed by or entered from the related applications or services. The tables may be related to one another according to a predefined database schema. For example, one table may be linked to another table according to one or more foreign keys, defining explicit foreign-key relationships, according to a database schema. As another example, specific rows of one or more tables may be interleaved within the specific rows of another table. These relationships may be used to define data integrity within the database, such that an incorrect data entry may be detected and avoided or corrected within the database quickly.

The test environment 110 can include a tester module 112 configured to conduct tests for the services 122 using test data populated in the test datastores by the database populator system. The tests can be any of a variety of tests that can be performed for conducting integration testing for new services or new or updated features for services currently in the production environment. In some examples, the tester module 112 is configured to test database contents to ensure data integrity.

Example tests can include testing the functionality of turning up a device in the production environment. For example, two kinds of data are pre-populated to each service or application of the services 122: (1) data that each device requires, like the state of the device, e.g., ready-to-be-turned-up, already-in-use, etc.; (2) data that each device is referenced from, such as from a resource allocator service that holds the data of all available devices, etc.

The request interceptor module 102 can receive datastore requests received by the DBMS 126 for the production datastores 124. Request interceptor module 102 can intercept the datastore requests as log entries, and construct the datastore requests from the log entries, to retrieve data responsive to the requests. Data responsive to datastore requests are referred to as request results. The request interceptor module 102 can be an RPC request interceptor, for example configured to intercept and/or intercept and log datastore requests for later construction.

The request interceptor module 102 can store the log entries for later construction of corresponding datastore requests. The request interceptor module 102 can log and store details for each datastore request, such as a name of a corresponding requested datastore, requested names for tables within the requested datastore, and/or other information. Other information can include column names and primary key values for the named columns, and for query operations, the complete query statement, for example written in a database querying language such as SQL. The intercepted log entries can be stored in datastore 103. Datastore 103 is encrypted, for example using a public-key cryptographic scheme. The request interceptor module 102 does not store request result data having personally identifiable information (PII) that may be present in the production datastores 124.

The request interceptor module 102 can be configured to intercept only read datastore requests for reading data, and not write datastore requests for writing data. In some examples, for example in RPC/REST microservice environments, a write (also called a create or update) request will almost always be preceded by a read datastore request or other user-provided data from a requesting device, as the results for the preceding request will act as the input for the write request. Therefore, it may be sufficient to only intercept the preceding read datastore request, instead of both the read and the write datastore request.

The request interceptor module 102 can intercept the datastore requests as log entries. The request interceptor module can intercept the datastore requests as the DBMS 126 receives the requests, or the request interceptor module 102 can access memory or persistent storage in which the log entries are temporarily or persistently stored. The system 100 can later construct the datastore requests based on the log entries, offline. To encrypt the intercepted datastore requests, the request interceptor module 102 for the datastore populator system can implement a common, shareable, public key. Datastore requests are intercepted by the request interceptor module 102 and encrypted using the public key.

The system 100 can include an invisible foreign-key identifier module (“identifier module”) 104. The identifier module can receive the log entries for the datastore requests intercepted by the request interceptor module 102 and group the entries by each datastore of the production datastores 124. The request interceptor module 102 can execute datastore requests corresponding to the received log entries and store the request results in-memory. As described presently, the identifier module 104 can generate a directed graph for representing invisible foreign-key relationships between tables across the production datastores 124.

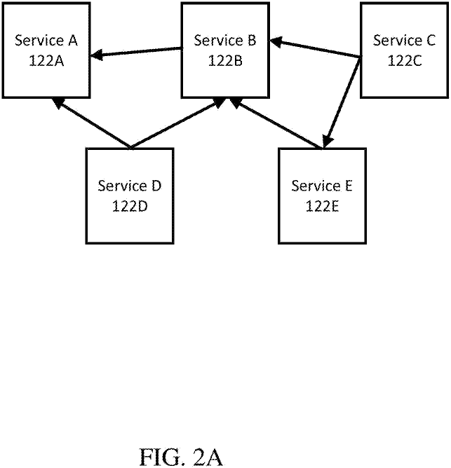

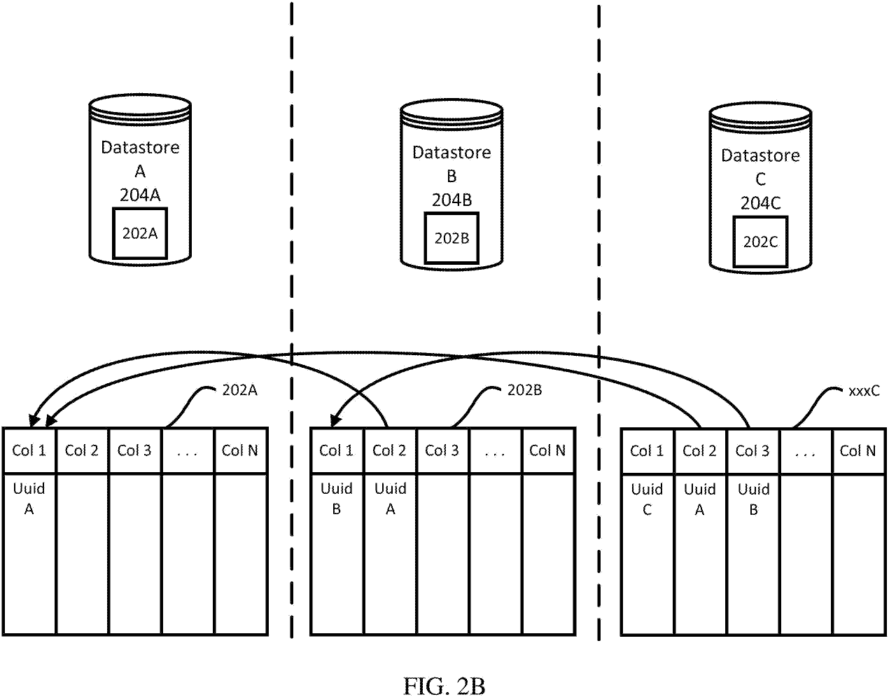

FIGS. 2A-2B illustrate how services can become interrelated according to dependencies created within various datastores or tables storing data generated by each service.

FIG. 2A is an illustration of interrelated services in a production environment. In FIG. 2A. The interrelated services shown in FIG. 2A include services A-E, 122A-122E. Services A 122A, B 122B can be, for example, workloads implemented in software for processing some input data and generating output data in response. At least some of the output data can be sent in response to the input data, for example as user output. As shown in FIG. 2B, at least some of the output data can be stored in a respective table corresponding to the service, for example in table A 202A for data generated by service A 122A, or in table B 202B for data generated by service B 122B. In some cases, it is possible for a value of a row in a column of table B 202B to come from an RPC call made to service A 122A.

Each service is connected to one or more other services through unidirectional edges. For example, service C 122C has two edges pointing to services B 122B and E 122E, respectively. This indicates that data used by services B 122B and E 122E depends on data stored in datastores or tables corresponding to service C 122C. As another example, service A 122A is connected to service B 122B by another edge point to service A 122A. This indicates that data used by service A 122A depends on data stored in datastores or tables corresponding to service B 122B.

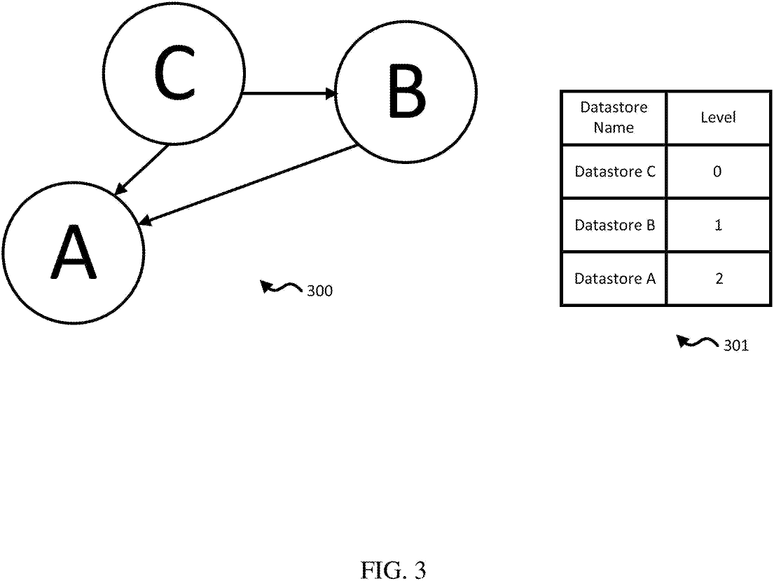

FIG. 2B is an illustration of invisible foreign-key relationships among tables of production datastores. Datastore A 204A stores table A 202A, datastore B 204B stores table B 202B, and datastore C 204C stores table C 202C. The datastores A-C 204A-204C can store data generated by services A-C 122A-122C of FIG. 2A, respectively. Each table 202A-202C is shown with N columns, although in practice the tables need not have the same number of columns. Unidirectional arrows represent invisible foreign-key relationships between the tables. The relationships are described as invisible and foreign-key because the tables 202A-202C do not have explicit foreign-key relationships, for example defined in a database schema, representing each of the relationships indicated by the unidirectional arrows in FIG. 3.

Each table 202A-202C includes one or more primary key columns, with values such as universally unique identifier (uuid) A, B, and C. A universally unique identifier (also referred to as a primary key) uniquely identifies a record in a table. The chances of two records being generated with the same uuid and that are not related to one another (e.g., one record depends on the other), is negligibly small. This generally holds true even for uuids generated across different datastores, such as among datastores 204A-204C. Generating primary keys as uuids is a common practice across different relational database technologies.

Returning to FIG. 1, the identifier module 104 uses this feature of primary keys as universally unique identifiers to identify invisible foreign-key relationships among the production datastores 124. The identifier module 104 can generate a node representing each datastore represented by the request results generated from the constructed datastore requests. An example node structure is provided in TABLE 1.

TABLE 1

| | |
|---|---|
| 1 | Node { |
| 2 | databaseName: <string>, |
| 3 | table_primary_key_values_map: <map<table_name, set<primary_key_value>>, |
| 4 | reverse_lookup_map:<unordered_map<all_values_in_a_row, pair<corresponding_column_name, table_name>>>, |
| 5 | } |

In the example definition of a node as shown in TABLE 1, the node includes a databaseName field storing a string for the name of the datastore represented by the node, for example “datastore A.” The example node definition also includes a table_primary_key_values_map, which is a map of primary keys in the represented datastore, as shown by line 3 of TABLE 1. Lastly, the example node definition can include a reverse_lookup_map, as shown in line 4 of TABLE 1. Initially, the identifier module 104 can create a directed graph with multiple nodes (one for each datastore) and no edges.

The identifier module 104 iterates through the request results saved in-memory and updates the table primary key values map for each node to include primary keys referenced in the request results. Also, for each node, the identifier module 104 populates the reverse lookup map with primary keys for tables of other datastores also represented in the directed graph.

For each datastore, the identifier module 104 compares the primary key saved to the corresponding node, against primary keys in the reverse lookup map. For each match, e.g., when a primary key in the primary key values map for a node matches a primary key in the reverse lookup map, the identifier module 104 generates a unidirectional edge from the node representing the table with the matched primary key to the current node. The directed edge can be from a {column, table, datastore} of the matching primary key, to the {column, table, datastore} of the current node being iterated through by the identifier module 104.

After iterating through each datastore, the identifier module 104 topologically sorts the graph, and stores the ordering of datastores according to the topological sort in a progress state table. A topological sort is a linear ordering of nodes in a directed graph. The ordering enforces the condition that, for each between a node A to a node B, node A comes before node B in the linear ordering. The identifier module 104 can implement any of a variety of different processes for topologically sorting the directed graph, for example, using Kahn’s algorithm or depth-first search. As the system sorts the graph, the system can update the progress state table as needed to track each datastore and its respective level. The system updates the levels of different datastores as needed, based on the linear ordering obtained for the graph from performing the topological sort.

In some examples, before performing the topological sort, the system can traverse the directed graph and identify any circular dependencies between two or more production datastores. If a circular dependency is identified, the nodes forming the circular dependency can be replaced with a composite node, representing the tables of the replaced nodes. The directed graph without circular dependencies may be a directed acyclic graph (DAG). The system sets the datastores of the replaced nodes to the same level in the progress state level for the graph. In the graph, the composite node is connected to one or more nodes according to edges connected to the replaced nodes. Using the ordered graph, the identifier module 104 generates a progress state table, which may be part of a data structure that also includes the directed graph.

FIG. 3 is an illustration of an example directed graph 300 and progress state table 301 generated by the database populator system, according to aspects of the disclosure. Nodes A-C represent the datastores A-C 204A-204C, as shown and described with reference to FIG. 2B. The ordering of the graph 300 according to a topological sort is {C, B, A}. The identifier module 104 traverses the ordered graph 300 and updates the progress state table 301. The progress state table 301 has a first entry, “datastore C” with a level of 0, indicating that the datastore C is in the first level. Datastore B is in level 1, as it depends on datastore C for at least some data, but does not depend on datastore A. Datastore A appears in level 2, as it depends on both datastore B and C.

The relative values of the levels between different levels can vary from implementation-to-implementation. For example, instead of the root node C being the lowest value, it can be the highest value, and all other levels are lower than the level of the root node C, accordingly.

The system 100 can include a test data generator module (“generator module”) 106 configured to populate the test datastores 114 using a progress state table for a directed graph. The generator module 106 populates data for lower levels before populating data for higher levels. For example, in the test datastores 114, a test datastore C is populated before a test datastore B or test datastore A. The generator module 106, using the progress state table, can populate the test datastores 114 of the test environment 110. The generator module 106 populates test datastores representing production datastores with lower levels in the progress state table, before populating test datastores representing production datastores with higher levels.

In the example of the progress state table 301 of FIG. 3, the generator module 106 populates a test datastore C with test data, before populating test datastores B and A. Because at least of the records in tables of the test datastores B and A will depend on data in test datastore C, the generator module 106 does not need to generate new data, and instead reuses test data from test datastore C, where appropriate. Similarly, when the generator module 106 populates test datastore A, the generator module 106 can at least partially reuse test generated for test datastores B and C. The value of the reuse, for example in fewer processing cycles or memory usage to generate new data, increases as the amount of invisible foreign-key relationships increases.

Test data can be populated from at least a portion of request results for database requests (with personally identifiable information removed), or at least partially synthetically (e.g., randomly) generated. The generator module 106 can receive parameters for generating random or synthetic data, for example schema, data type, and data range constraints. The generator module 106, through the use of the progress state table, generates test data that satisfies the invisible foreign-key relationships of the data in the production datastores 124.

In some examples, the generator module 106 can be implemented as multiple workers populating test datastores in parallel. To maintain concurrency control, the workers’ workloads are assigned according to the level data in the progress state table for the graph, so that a workload depending on parent data is not assigned before a workload for populating the parent data. For example, if a progress state table has three datastores at level 0, then the generator module 106 can assign separate workers to populate test data for corresponding test datastores for the level 0 datastores, before assigning workers to populate test datastores for level 1 and so on. The progress state table can provide concurrency control for concurrent implementations of the system 100, without requiring additional processing.

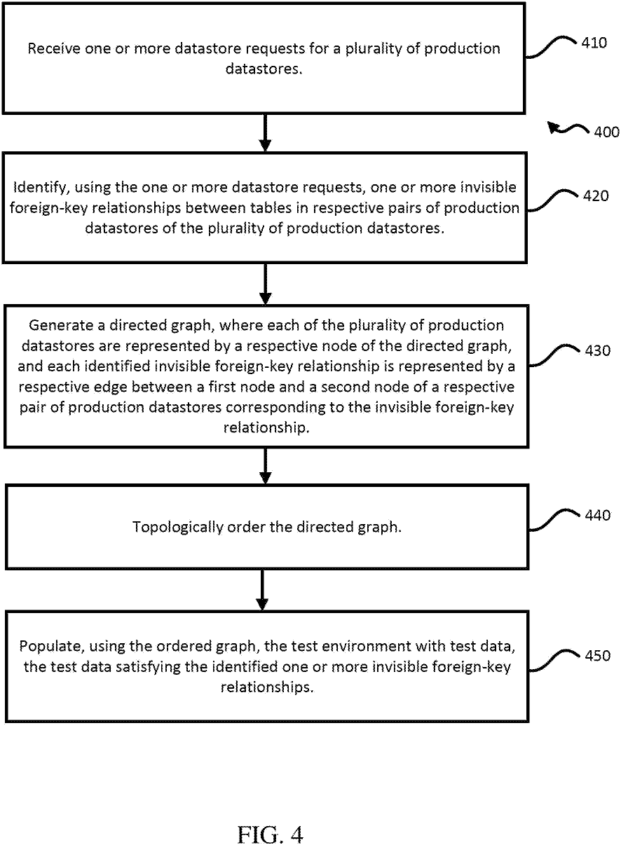

FIG. 4 is a flow diagram of an example process 400 for populating a test environment with test data, according to aspects of the disclosure.

A datastore populator system including one or more processors can receive one or more datastore requests for a plurality of production datastores, according to block 410. For example, to receive the one or more datastore requests, the system can intercept datastore requests between production datastores of a production environment, and a requesting device or datastore management system. After intercepting the datastore requests, the system can store the requests in persistent storage for identifying the invisible foreign-key relationships and generating the directed graph. In some examples, the system intercepts only read requests for reading request results from the plurality of production datastores.

The system identifies, using the one or more datastore requests, one or more invisible foreign-key relationships between tables in respective pairs of production datastores of the plurality of production datastores, according to block 420. As described herein, invisible foreign-key relationships can be any level of granularity within two datastores, for example by individual record or by table.

To identify the one or more datastore requests, the system can execute the one or more datastore requests to generate one or more request results. Each request result can correspond to a record of a table with a primary-key identifier, or another unique identifier stored in a column for the table. The system can compare primary key-identifiers among the tables and identify invisible foreign-key relationships between tables storing rows with matching primary-key identifiers.

The system generates a directed graph, according to block 430. In the directed graph, each of the plurality of production datastores are represented by a respective node of the directed graph, and each identified invisible foreign-key relationship is represented by a respective edge between a first node and a second node of a respective pair of production datastores corresponding to the invisible foreign-key relationship. The edges are unidirectional, each edge pointing to the table with data depending on data in a table on the other side of the edge. The edges point from a current {column, table, datastore} to a matching {column, table, datastore}.

The system topologically orders the directed graph, according to block 440. The system resolves any circular dependencies and generates composite nodes from the circularly dependent nodes, as necessary, before performing the topological sort.

The system populates the test environment with test data, using the ordered graph, according to block 450. The test data satisfies the identified one or more invisible foreign-key relationships. To populate the test environment with test data while satisfying the invisible foreign-key relationships, the system can traverse the ordered graph according to the topological order. The system uses the progress state table for the node to populate data in order of level, so that records that are depended on by other records are populated first. Example

### Computing Environment

FIG. 5 is a block diagram of an example environment 500 for implementing the datastore populator system 100. The system 100 can be implemented on one or more devices having one or more processors in one or more locations, such as in server computing device 515. User computing device 512 and the server computing device 515 can be communicatively coupled to one or more storage devices 530 over a network 560. The user computing device 512 can be a requesting device, as described herein with reference to FIG. 1.

The storage device(s) 530 can be a combination of volatile and non-volatile memory or persistent storage devices and can be at the same or different physical locations than the computing devices 512, 515. For example, the storage device(s) 530 can include any type of non-transitory computer readable medium capable of storing information, such as a hard-drive, solid state drive, tape drive, optical storage, memory card, ROM, RAM, DVD, CD-ROM, write-capable, and read-only memories. The storage device(s) 530 can include production and/or test datastores 124, 114 described herein with reference to FIG. 1.

The server computing device 515 can include one or more processors 513 and memory 514. The memory 514 can store information accessible by the processor(s) 513, including instructions 521 that can be executed by the processor(s) 513. The memory 514 can also include data 523 that can be retrieved, manipulated, or stored by the processor(s) 513. The memory 514 can be a type of non-transitory computer readable medium capable of storing information accessible by the processor(s) 513, such as volatile and non-volatile memory. The processor(s) 513 can include one or more central processing units (CPUs), graphic processing units (GPUs), field-programmable gate arrays (FPGAs), and/or application-specific integrated circuits (ASICs), such as tensor processing units (TPUs).

The instructions 521 can include one or more instructions that when executed by the processor(s) 513, causes the one or more processors to perform actions defined by the instructions. The instructions 521 can be stored in object code format for direct processing by the processor(s) 513, or in other formats including interpretable scripts or collections of independent source code modules that are interpreted on demand or compiled in advance. The instructions 521 can include instructions for implementing the system 100 consistent with aspects of this disclosure. The system 100 can be executed using the processor(s) 513, and/or using other processors remotely located from the server computing device 515.

The data 523 can be retrieved, stored, or modified by the processor(s) 513 in accordance with the instructions 521. The data 523 can be stored in computer registers, in a relational or non-relational database as a table having a plurality of different fields and records, or as JSON, YAML, proto, or XML documents. The data 523 can also be formatted in a computer-readable format such as, but not limited to, binary values, ASCII, or Unicode. Moreover, the data 523 can include information sufficient to identify relevant information, such as numbers, descriptive text, proprietary codes, pointers, references to data stored in other memories, including other network locations, or information that is used by a function to calculate relevant data.

The user computing device 512 can also be configured similar to the server computing device 515, with one or more processors 516, memory 517, instructions 518, and data 519. The user computing device 512 can also include a user output 526, and a user input 524. The user input 524 can include any appropriate mechanism or technique for receiving input from a user, such as keyboard, mouse, mechanical actuators, soft actuators, touchscreens, microphones, and sensors. The user computing device 512 can be a requesting device sending datastore requests to a datastore management system for the production environment 120.

The server computing device 515 can be configured to transmit data to the user computing device 512, and the user computing device 512 can be configured to display at least a portion of the received data on a display implemented as part of the user output 526. The user output 526 can also be used for displaying an interface between the user computing device 512 and the server computing device 515. The user output 526 can alternatively or additionally include one or more speakers, transducers or other audio outputs, a haptic interface or other tactile feedback that provides non-visual and non-audible information to the platform user of the user computing device 512.

The environment 500 can include one or both of the production environment 120 and the test environment 110. The environments 110, 120 can be implemented across one or more devices, using a combination of processors, memory, and storage devices as described herein with reference to the environment 500.

Although FIG. 5 illustrates the processors 513, 516 and the memories 514, 517 as being within the computing devices 515, 512, components described in this specification, including the processors 513, 516 and the memories 514, 517 can include multiple processors and memories that can operate in different physical locations and not within the same computing device. For example, some of the instructions 521, 518 and the data 523, 519 can be stored on a removable SD card and others within a read-only computer chip. Some or all of the instructions and data can be stored in a location physically remote from, yet still accessible by, the processors 513, 516. Similarly, the processors 513, 516 can include a collection of processors that can perform concurrent and/or sequential operation. The computing devices 515, 512 can each include one or more internal clocks providing timing information, which can be used for time measurement for operations and programs run by the computing devices 515, 512.

The server computing device 515 can be configured to receive requests to process data from the user computing device 512. For example, the environment 500 can be part of a computing platform configured to provide a variety of services to users, through various user interfaces and/or APIs exposing the platform services. One or more services can be a machine learning framework or a set of tools for generating neural networks or other machine learning models according to a specified task and training data. The user computing device 512 may receive and transmit data specifying target computing resources to be allocated for executing a neural network trained to perform a particular neural network task.

The devices 512, 515 can be capable of direct and indirect communication over the network 560. The devices 515, 512 can set up listening sockets that may accept an initiating connection for sending and receiving information. The network 560 itself can include various configurations and protocols including the Internet, World Wide Web, intranets, virtual private networks, wide area networks, local networks, and private networks using communication protocols proprietary to one or more companies. The network 560 can support a variety of short- and long-range connections. The short- and long-range connections may be made over different bandwidths, such as 2.402 GHz to 2.480 GHz (commonly associated with the Bluetooth® standard), 2.4 GHz and 5 GHz (commonly associated with the Wi-Fi® communication protocol); or with a variety of communication standards, such as the LTE® standard for wireless broadband communication. The network 560, in addition or alternatively, can also support wired connections between the devices 512, 515, including over various types of Ethernet connection.

Although a single server computing device 515, user computing device 512, and datacenter 550 are shown in FIG. 5, it is understood that the aspects of the disclosure can be implemented according to a variety of different configurations and quantities of computing devices, including in paradigms for sequential or parallel processing, or over a distributed network of multiple devices. In some implementations, aspects of the disclosure can be performed on a single device, and any combination thereof.

Aspects of this disclosure can be implemented in digital circuits, computer-readable storage media, as one or more computer programs, or a combination of one or more of the foregoing. The computer-readable storage media can be non-transitory, e.g., as one or more instructions executable by a cloud computing platform and stored on a tangible storage device.

In this specification the phrase “configured to” is used in different contexts related to computer systems, hardware, or part of a computer program, engine, or module. When a system is said to be configured to perform one or more operations, this means that the system has appropriate software, firmware, and/or hardware installed on the system that, when in operation, causes the system to perform the one or more operations. When some hardware is said to be configured to perform one or more operations, this means that the hardware includes one or more circuits that, when in operation, receive input and generate output according to the input and corresponding to the one or more operations. When a computer program, engine, or module is said to be configured to perform one or more operations, this means that the computer program includes one or more program instructions, that when executed by one or more computers, causes the one or more computers to perform the one or more operations.

While operations shown in the drawings and recited in the claims are shown in a particular order, it is understood that the operations can be performed in different orders than shown, and that some operations can be omitted, performed more than once, and/or be performed in parallel with other operations. Further, the separation of different system components configured for performing different operations should not be understood as requiring the components to be separated. The components, modules, programs, and engines described can be integrated together as a single system or be part of multiple systems.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the examples should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible implementations. Further, the same reference numbers in different drawings can identify the same or similar elements.

With respect to the use of substantially any plural and/or singular terms herein, for example (with the term “element” being a stand-in for any system, component, data, etc.) “an/the element,” “one or more elements,” “multiple elements,” a “plurality of elements,” “at least one element,” etc., those having skill in the art can translate from the plural to the singular and/or from the singular to the plural as is appropriate to the context and/or application described. The various singular/plural permutations may be expressly set forth herein, for sake of clarity and without limitation unless expressly indicated.

1. A method for populating test data in a test environment for a plurality of production datastores comprising a plurality of tables, the method comprising:
receiving, by one or more processors, one or more datastore requests for the plurality of production datastores;
identifying, by the one or more processors, and using the one or more datastore requests, one or more invisible foreign-key relationships between respective pairs of tables in the plurality of production datastores;
generating, by the one or more processors, a directed graph, wherein each of the plurality of production datastores is represented by a respective node of the directed graph and each identified invisible foreign-key relationship is represented by a respective edge between a first node and a second node of a respective pair of tables corresponding to the invisible foreign-key relationship;
topologically ordering, by the one or more processors, the directed graph; and
populating, by the one or more processors and using the ordered graph, the test environment with the test data, the test data satisfying the identified one or more invisible foreign-key relationships.

2. The method of claim 1, wherein receiving, by the one or more processors, the one or more datastore requests to the plurality of production datastores comprises:
intercepting the one or more datastore requests over a network connecting the plurality of production datastores with a requesting device; and
storing the one or more datastore requests in persistent storage.

3. The method of claim 2, wherein intercepting the one or more datastore requests comprises intercepting only read requests for reading request results from the plurality of production datastores.

4. The method of claim 2, wherein identifying, by the one or more processors, and using the one or more datastore requests, the one or more invisible foreign-key relationships, comprises:
executing the one or more datastore requests to generate one or more request results, wherein each request result corresponds to a record of a respective table with a primary-key identifier stored in a column of the respective table; and
comparing, for a first request result, the primary-key identifier for the first request result with primary-key identifiers in other tables, and for each matched primary-key identifier, identifying an invisible foreign-key relationship between the table storing the first result and the table storing the result corresponding to the matched primary-key identifier.

5. The method of claim 4, wherein the test data comprises at least a portion of the one or more request results.

6. The method of claim 1,
wherein the directed graph comprises a progress state table, and
wherein topologically sorting the directed graph comprises updating, for each node, the progress state table with a name of a datastore represented by the node and a respective level in the ordering for the datastore.

7. The method of claim 6, wherein populating the test environment data comprises:
traversing the ordered graph; and
populating data across tables for each node concurrently, in accordance with the updated levels in the progress state table.

8. The method of claim 6, wherein populating the test environment comprises:
populating the test environment with the test data using the progress state table of the directed graph to satisfy the one or more identified invisible foreign-key relationships.

9. The method of claim 1, wherein the method further comprises:
identifying a circular dependency between two or more production datastores, according to the topological sorting; and
replacing nodes corresponding with the two or more production datastores with a composite node, the composite node connected to one or more nodes according to edges for nodes to the two or more production datastores.

10. The method of claim 1, wherein the directed graph is a directed acyclic graph (DAG).

11. A system comprising:
one or more processors configured to:
receive, by the one or more processors, one or more datastore requests for the plurality of production datastores;
identify, by the one or more processors, and using the one or more datastore requests, one or more invisible foreign-key relationships between respective pairs of tables the plurality of production datastores;
generate, by the one or more processors, a directed graph, wherein each of the plurality of production datastores is represented by a respective node of the directed graph and each identified invisible foreign-key relationship is represented by a respective edge between a first node and a second node of a respective pair of tables corresponding to the invisible foreign-key relationship;
topologically order, by the one or more processors, the directed graph; and
populate, by the one or more processors and using the ordered graph, the test environment with the test data, the test data satisfying the identified one or more invisible foreign-key relationships.

12. The system of claim 11, wherein in receiving the one or more datastore requests to the plurality of production datastores, the one or more processors are configured to:
intercept the one or more datastore requests over a network connecting the plurality of production datastores with a requesting device; and
store the one or more datastore requests in persistent storage.

13. The system of claim 12, wherein in intercepting the one or more datastore requests, the one or more processors are configured to intercept only read requests for reading request results from the plurality of production datastores.

14. The system of claim 12, wherein in identifying, using the one or more datastore requests, the one or more invisible foreign-key relationships, the one or more processors are configured to:
execute the one or more datastore requests to generate one or more request results, wherein each request result corresponds to a record of a respective table with a primary-key identifier stored in a column of the respective table; and
compare, for a first request result, the primary-key identifier for the first request result with primary-key identifiers in other tables, and for each matched primary-key identifier, identifying an invisible foreign-key relationship between the table storing the first result and the table storing the result corresponding to the matched primary-key identifier.

15. The system of claim 14, wherein the test data comprises at least a portion of the one or more request results.

16. The system of claim 11,
wherein the directed graph comprises a progress state table, and
wherein in topologically sorting the directed graph, the one or more processors are configured to update, for each node, the progress state table with a name of a datastore represented by the node and a respective level in the ordering for the datastore.

17. The system of claim 16, wherein in populating the test environment data, the one or more processors are configured to:
traverse the ordered graph; and
populate data across tables for each node concurrently, in accordance with the updated levels in the progress state table.

18. The system of claim 16, wherein in populating the test environment, the one or more processors are configured to populate the test environment with the test data using the progress state table to satisfy the one or more identified invisible foreign-key relationships.

19. The system of claim 11, wherein the one or more processors are further configured to:
identify a circular dependency between two or more production datastores, according to the topological sorting; and
replace nodes corresponding with the two or more production datastores with a composite node, the composite node connected to one or more nodes according to edges for nodes to the two or more production datastores.

20. One or more non-transitory computer-readable storage media having instructions that when executed by one or more processors, causes the one or more processors to perform operations, comprising:
receiving one or more datastore requests for the plurality of production datastores;
identifying using the one or more datastore requests, one or more invisible foreign-key relationships between respective pairs of tables in the plurality of production datastores;
generating a directed graph, wherein each of the plurality of production datastores is represented by a respective node of the directed graph and each identified invisible foreign-key relationship is represented by a respective edge between a first node and a second node of a respective pair of tables corresponding to the invisible foreign-key relationship;
topologically ordering the directed graph; and
populating, using the ordered graph, the test environment with the test data, the test data satisfying the identified one or more invisible foreign-key relationships.
